(19) United States
(12) Patent Application Publication
(10) Pub. No.: US 2024/0127440 A1
(43) Pub. Date: Apr. 18, 2024

(54) MANUFACTURING METHOD OF LEARNING MODEL, LEARNING MODEL, ESTIMATION METHOD, IMAGE PROCESSING SYSTEM, AND PROGRAM

(71) Applicant: FUJIFILM Corporation, Tokyo (JP)

(72) Inventor: Taro HATSUTANI, Tokyo (JP)

(73) Assignee: FUJIFILM Corporation, Tokyo (JP)

(21) Appl. No.: 18/481,206

(22) Filed: Oct. 4, 2023

(30) Foreign Application Priority Data
Oct. 14, 2022 (JP) 2022-165783

(51) Int. Cl. G06T 7/00; G06T 3/60; G06T 7/50; G06V 10/25; G06V 10/74

(52) U.S. Cl. CPC G06T 7/0012; G06T 3/60; G06T 7/50; G06V 10/25; G06V 10/761; G06V 2201/03; G06V 2201/07

(57) ABSTRACT

An object of the present invention is to provide a manufacturing method of a learning model, a learning model, an estimation method, an image processing system, and a program, which are capable of efficiently generating a large amount of learning data and of performing training on a learning model to which the efficiently generated large amount of learning data is applied.

A manufacturing method of a learning model includes acquiring a region of a normal object included in a processing target image as a first mask, generating a second mask by changing a state of the first mask, and performing training to estimate a difference between the second mask and the first mask as a region-of-interest or performing training to estimate the first mask from the second mask, using the first mask and the second mask as learning data.

### CROSS-REFERENCE TO RELATED APPLICATION

The present application claims priority under 35 U.S.C § 119(a) to Japanese Patent Application No. 2022-165783 filed on Oct. 14, 2022, which is hereby expressly incorporated by reference, in its entirety, into the present application.

### BACKGROUND OF THE INVENTION

### 1. Field of the Invention

The present invention relates to a manufacturing method of a learning model, a learning model, an estimation method, an image processing system, and a program.

### 2. Description of the Related Art

Segmentation is known as one of the image recognition technologies. Segmentation is a process of extracting one or more objects from an image. Segmentation has made progress due to the development of machine learning models.

In a learning model of segmentation, mask learning is generally performed. A mask is understood as a region such as a region of interest extracted from the image. However, since mask creation requires a high cost, there are cases where a simulation image is used instead of the mask. On the other hand, in the case of utilizing the simulation image, there is a problem in that a domain gap is generated.

JP6911915B describes an image processing apparatus that detects a change related to a product shelf from a captured image where a product shelf is imaged, that classifies the detected changes, and that evaluates a display state of a display shelf of a product.

The apparatus described in JP6911915B specifies a change region by using a foreground image and a background image in the captured image where a product shelf is imaged.

### SUMMARY OF THE INVENTION

However, a large amount of correct answer data is required for training a segmentation model that extracts a region deviating from a normal region as a region-of-interest. On the other hand, it takes time to create a large amount of correct answer data.

The apparatus described in JP6911915B detects a change related to the product shelf by using a shelf change model that models a change in the product shelf that has been trained in advance. The disclosure related to learning data of the shelf change model in JP6911915B does not include the description of the above-described problem related to the acquisition of the correct answer data.

The present invention has been made in view of such circumstances, and an object is to provide a manufacturing method of a learning model, a learning model, an estimation method, an image processing system, and a program, which are capable of efficiently generating a large amount of learning data and of performing training on a learning model to which the efficiently generated large amount of learning data is applied.

A manufacturing method of a learning model according to a first aspect of the present disclosure is a manufacturing method of a learning model that estimates a region-of-interest or that estimates a normal region, for an object included in an image, based on a state change with respect to a normal object having a defined state, the manufacturing method of a learning model comprises: causing a computer to: acquire a region of the normal object included in a processing target image as a first mask; generate a second mask by changing a state of the first mask; and perform training to estimate a difference between the second mask and the first mask as the region-of-interest or perform training to estimate the first mask from the second mask, using the first mask and the second mask as learning data.

According to the manufacturing method of the learning model according to the first aspect, the second mask can be generated by changing the first mask representing a normal region of the object, and the pair of the first mask and the second mask can be efficiently acquired as a large amount of learning data. Accordingly, it is possible to manufacture a learning model trained using the pair of the first mask and the second mask as the learning data.

In the manufacturing method of a learning model of a second aspect according to the manufacturing method of the learning model of the first aspect, a medical image may be applied to the processing target image, and an anatomical structure may be applied as the object.

According to such an aspect, the learning model used for the medical image is manufactured.

In the manufacturing method of a learning model of a third aspect according to the manufacturing method of the learning model of the second aspect, in a case where the second mask is generated, a shape simulating a lesion may be combined with the first mask to deform a shape of the first mask.

According to such an aspect, the second mask based on the shape of the lesion can be obtained.

In the manufacturing method of a learning model of a fourth aspect according to the manufacturing method of the learning model of the second aspect, in a case where the second mask is generated, a shape that is recognized as an omission of the anatomical structure may be omitted from the first mask.

According to such an aspect, it is possible to acquire the second mask obtained by deforming the first mask by simulating omission of the anatomical structure.

In the manufacturing method of a learning model of a fifth aspect according to the manufacturing method of the learning model of the first aspect, in a case where the second mask is generated, a shape of the first mask may be made to expand or the shape of the first mask may be made to contract.

According to such an aspect, it is possible to acquire the second mask corresponding to the expansion of the normal region and to acquire the second mask corresponding to the contraction of the normal region.

In the manufacturing method of a learning model of a sixth aspect according to the manufacturing method of the learning model of the first aspect, in a case where the second mask is generated, an abnormality simulated shape simulating an abnormality may be combined with the first mask to deform a shape of the first mask.

According to such an aspect, it is possible to acquire the second mask in which the abnormality simulated shape that simulates an abnormality is combined with the first mask.

In the manufacturing method of a learning model of a seventh aspect according to the manufacturing method of the learning model of the sixth aspect, in a case where the second mask is generated, a plurality of the abnormality simulated shapes may be combined with the first mask.

According to such an aspect, it is possible to cope with a case where a plurality of abnormal regions are present with respect to one object.

In the manufacturing method of a learning model of an eighth aspect according to the manufacturing method of the learning model of the sixth aspect, in a case where the second mask is generated, the abnormality simulated shape, which is rotated, may be combined with the first mask.

According to such an aspect, a plurality of second masks can be acquired from one abnormality simulated shape.

In the manufacturing method of a learning model of a ninth aspect according to the manufacturing method of the learning model of the first aspect, in a case where the second mask is generated, an abnormality simulated shape simulating an abnormality may be omitted from the first mask to deform a shape of the first mask.

According to such an aspect, it is possible to cope with a case where an abnormal region, which is recognized as an omission, is present.

A learning model according to a tenth aspect of the present disclosure is a learning model that estimates a region-of-interest or that estimates a normal region, for an object included in an image, based on a state change with respect to a normal object having a defined state, the learning model trained to: estimate a difference between the second mask and the first mask as the region-of-interest or estimate the first mask from the second mask using a first mask representing a region of the normal object included in a processing target image and a second mask generated by changing a state of the first mask as learning data.

According to the learning model according to the tenth aspect, it is possible to obtain the same effects as the manufacturing method of the learning model according to the first aspect. The configuration requirements of the manufacturing method of the learning model according to the second to fourteenth aspects can be applied to the configuration requirements of the learning model according to the other aspects.

An estimation method according to an eleventh aspect of the present disclosure is an estimation method of estimating a region-of-interest or of estimating a normal region, for an object included in an image, based on a state change with respect to a normal object having a defined state, the estimation method comprises: causing a computer to: extract a region of an object included in a processing target image as a third mask; and estimate, from the third mask, a region deviating from a region of the normal object as the region-of-interest or estimate the normal region from the third mask.

According to the estimation method according to the eleventh aspect, a learning model, which is trained by using a large amount of efficiently generated learning data, can be applied to perform estimation of a region-of-interest or a normal region for an object included in an image.

An image processing system according to a twelfth aspect of the present disclosure is an image processing system that estimates a region-of-interest or of estimating a normal region, for an object included in an image, based on a state change with respect to a normal object having a defined state, the image processing system comprises: one or more processors, in which the one or more processors are configured to: execute a program command; extract a region of an object included in a processing target image as a third mask; and estimate, from the third mask, a region deviating from a region of the normal object as the region-of-interest or estimate the normal region from the third mask.

According to the image processing system according to the twelfth aspect, it is possible to obtain the same effects as the estimation method according to the eleventh aspect.

A program according to a thirteenth aspect of the present disclosure is a program for estimating a region-of-interest or for estimating a normal region, for an object included in an image, based on a state change with respect to a normal object having a defined state, the program causes a computer to realize: a function of extracting a region of an object included in a processing target image as a third mask; and a function of estimating, from the third mask, a region deviating from a region of the normal object as the region-of-interest or of estimating the normal region from the third mask.

According to the program according to the thirteenth aspect, it is possible to obtain the same effects as the estimation method according to the eleventh aspect.

According to the present disclosure, the second mask can be generated by changing the first mask representing a normal region of the object, and the pair of the first mask and the second mask can be efficiently acquired as a large amount of learning data. Accordingly, it is possible to manufacture a learning model trained using the pair of the first mask and the second mask as the learning data.

### BRIEF DESCRIPTION OF THE DRAWINGS

FIG. 1 is a flowchart showing a flow of a procedure of a manufacturing method of a learning model according to an embodiment.

FIG. 2 is a flowchart showing a procedure of a mask deformation processing step shown in FIG. 1.

FIG. 3 is a schematic diagram showing a specific example of the manufacturing method of the learning model according to the embodiment.

FIG. 4 is a functional block diagram showing an electric configuration of a learning model manufacturing system according to the embodiment.

FIG. 5 is a block diagram schematically showing an example of a hardware configuration of the learning model manufacturing system according to the embodiment.

FIG. 6 is a flowchart showing a procedure of another aspect of the mask deformation processing step shown in FIG. 1.

FIG. 7 is a flowchart showing a flow of a procedure of a manufacturing method of a learning model according to a modification example.

FIG. 8 is a schematic diagram showing a specific example of acquiring a first mask.

FIG. 9 is a schematic diagram showing another specific example of acquiring the first mask.

FIG. 10 is a schematic diagram showing a specific example of a deformation mask.

FIG. 11 is a schematic diagram showing a first specific example of acquiring a second mask.

FIG. 12 is a schematic diagram showing a second specific example of acquiring a second mask.

FIG. 13 is a schematic diagram showing a third specific example of acquiring a second mask.

FIG. 14 is a schematic diagram showing a fourth specific example of acquiring a second mask.

FIG. 15 is a schematic diagram of an estimation model.

FIG. 16 is a schematic diagram of another example of the estimation model.

FIG. 17 is a flowchart showing a procedure of an estimation method according to the embodiment.

FIG. 18 is a conceptual diagram of the estimation method shown in FIG. 17.

FIG. 19 is a functional block diagram showing an electric configuration of an image processing system according to the embodiment.

FIG. 20 is a block diagram schematically showing an example of a hardware configuration of the image processing system shown in FIG. 19.

FIG. 21 is a schematic diagram showing an application example to a medical image.

### DESCRIPTION OF THE PREFERRED EMBODIMENTS

Hereinafter, preferred embodiments of the present invention will be described with reference to the accompanying drawings. In the present specification, the same components are designated by the same reference numerals, and duplicate descriptions thereof will be omitted as appropriate.

### Outline of Manufacturing Method of Learning Model

Hereinafter, a manufacturing method of a learning model that performs a segmentation will be described. Here, segmentation for extracting an abnormal region deviating from a normal region as a region-of-interest will be given as an example for an image. A processing target image may be a two-dimensional image or a three-dimensional image. Examples of an image include a captured image that is obtained by imaging a subject using an imaging device.

The manufacture of a learning model can be understood as a term representing the construction of a learning model, such as generation of a learning model and creation of a learning model. The abnormal region described in an embodiment is an example of a region of interest based on a state change with respect to a normal object having a defined state.

The captured image may be a medical image in which an anatomical structure of a human body is imaged or may be an inspection image of an industrial product in which the industrial product is imaged. The captured image may be an image in which architecture such as a building, a road, or a bridge is imaged or may be a natural image in which a natural object such as a landscape is imaged. The term “image” can include the meaning of image data which is a signal indicating an image.

### Procedure of Manufacturing Method of Learning Model

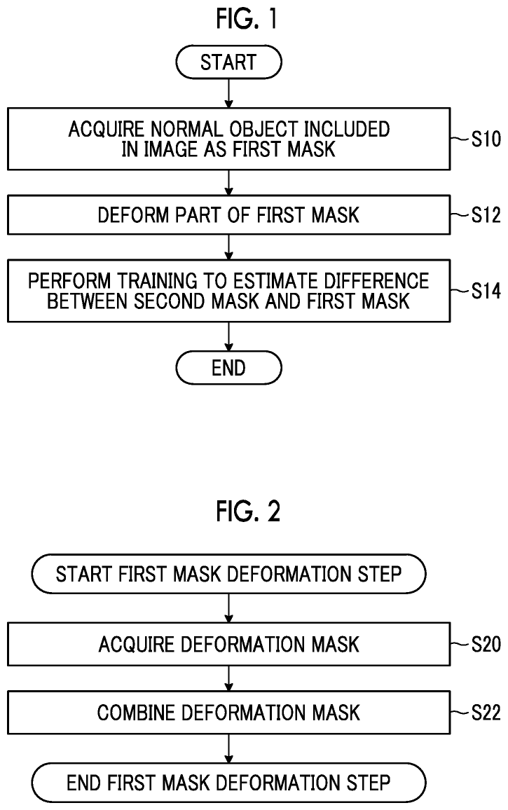

FIG. 1 is a flowchart showing a flow of a procedure of a manufacturing method of a learning model according to the embodiment. In the manufacturing method of the learning model shown in FIG. 1, a computer executes a program to execute each step. The number of computers that execute each step included in the manufacturing method of the learning model may be one or a plurality of computers. The computer may be a virtual machine.

In a first mask acquisition step S10, a normal object included in an image is acquired as a first mask. The normal object is a predetermined object in a normal state. In the case of a medical image, a normal anatomical structure such as a normal organ, nerve, bone, and muscle is applied as the normal object.

In the first mask acquisition step S10, a plurality of first masks may be acquired from one image. The acquisition may include an aspect in which a normal object is extracted from the processing target image. The acquisition may include an aspect of acquiring a normal object extracted from the processing target image in advance.

The first mask acquisition step S10 may include a storing step of storing the acquired first mask. In a case where the first mask is stored, identification information such as a name of an object may be added to each of the first masks. After the first mask acquisition step S10, the process proceeds to a first mask deformation processing step S12.

In the first mask deformation processing step S12, a second mask is generated by deforming a part of the first mask acquired in the first mask acquisition step S10. In the first mask deformation processing step S12, a plurality of second masks different from each other are generated. The first mask deformation processing step S12 described in the embodiment is an example of a step of generating a second mask by changing a state of the first mask.

Among the steps included in the manufacturing method of the learning model shown in FIG. 1, a procedure including the first mask acquisition step S10 and the first mask deformation processing step S12 can be understood as a procedure of a manufacturing method of learning data. After the first mask deformation processing step S12, the process proceeds to a learning step S14.

In the learning step S14, training is performed to estimate a difference obtained by subtracting the first mask from the second mask, using a pair of the first mask acquired in the first mask acquisition step S10 and the second mask created in the first mask deformation processing step S12 as the learning data. The learning model manufactured by executing each step from the first mask acquisition step S10 to the learning step S14 can function as an estimation model of estimating the region-of-interest from the processing target image.

### Specific Example of Mask Deformation Processing

FIG. 2 is a flowchart showing a procedure of the mask deformation processing step shown in FIG. 1. In the mask deformation processing step, a deformation mask different from the first mask may be superimposed on the first mask, and a deformation process of the first mask, which is considered to be a deformed version of the first mask, may be performed.

That is, the first mask deformation processing step S12 includes a deformation mask acquisition step S20 and a deformation mask composition step S22. In the deformation mask acquisition step S20, a deformation mask that is different from the first mask and that simulates an abnormal region deviating from the normal region is acquired. The acquisition of the deformation mask may include generation of the deformation mask and modification of the deformation mask.

In the deformation mask acquisition step S20, a plurality of deformation masks different from each other are acquired. A plurality of deformation masks having similar shapes to each other are understood as a plurality of deformation masks different from each other. A deformation mask obtained by rotating any deformation mask is understood as a deformation mask different from the deformation mask before the rotation. After the deformation mask acquisition step S20, the process proceeds to the deformation mask composition step S22.

In the deformation mask composition step S22, each of the plurality of deformation masks acquired in the deformation mask acquisition step S20 is combined with the first mask, and a plurality of second masks different from each other are generated. Examples of the composition referred to here include a process of embedding a deformation mask with respect to the first mask.

### Specific Example of Manufacturing Method of Learning Model

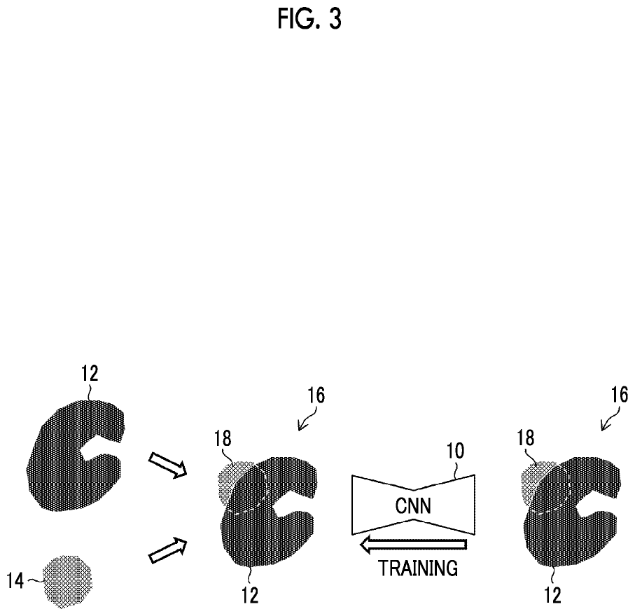

FIG. 3 is a schematic diagram showing an outline of the manufacturing method of the learning model according to the embodiment. In FIG. 3, an example is shown in which a normal kidney region in a medical image is acquired as a first mask 12, a sphere that simulates a tumor is acquired as a deformation mask 14, and a second mask 16 in which a part of the deformation mask 14 is exposed from an outer periphery of the first mask 12 is generated. The second mask 16 described in the embodiment is an example of an abnormality simulated shape that simulates an abnormality.

FIG. 3 illustrates a CNN as a learning method of the learning model 10. The CNN is an abbreviation of Convolution Neural Network in English. The CNN is a forward propagation type network including an input layer, a convolutional layer, a pooling layer, a fully-connected layer, and an output layer. The CNN may include a plurality of convolutional layers or may include a plurality of pooling layers.

In the learning model 10 shown in FIG. 3, training is performed using the first mask 12 and the second mask 16 as the learning data, and the learning model 10, which estimates a difference 18 from the second mask 16, is generated. The learning model 10 is a learning model that is trained such that the difference 18 is output in a case where the second mask 16 is input.

The learning model 10 may be a learning model that is trained such that the first mask 12 is output in a case where the second mask 16 is input. The difference 18 corresponds to a portion of the second mask 16 exposed from the outer periphery of the first mask 12.

### Electric Configuration of Learning Model Manufacturing System

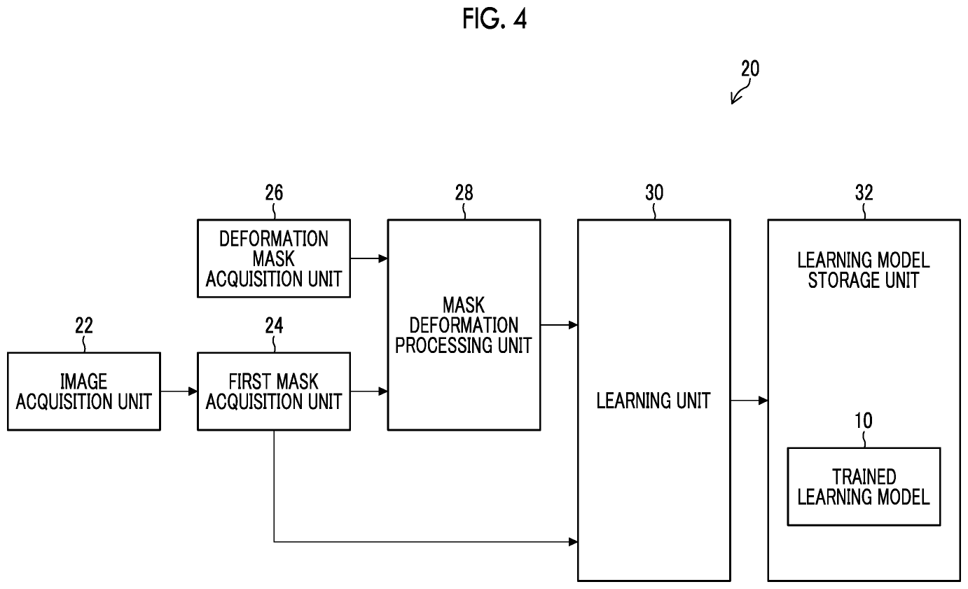

FIG. 4 is a functional block diagram showing an electric configuration of a learning model manufacturing system according to the embodiment. The learning model manufacturing system 20 shown in FIG. 4 includes an image acquisition unit 22, a first mask acquisition unit 24, a deformation mask acquisition unit 26, a mask deformation processing unit 28, a learning unit 30, and a learning model storage unit 32.

The image acquisition unit 22 acquires the processing target image. The image acquisition unit 22 may acquire the processing target image from an image database. The image database may be an external device or an internal device of the learning model manufacturing system 20.

The image acquisition unit 22 may acquire an image from an imaging device that is connected via a network in a communicable manner. The imaging device may be an imaging device that acquires a medical image, such as an endoscope device or an X-ray imaging device.

The first mask acquisition unit 24 acquires a normal object as the first mask 12 from the image acquired by the image acquisition unit 22. The first mask acquisition unit 24 executes the first mask acquisition step S10 shown in FIG. 1. The first mask acquisition unit 24 may be applied to an extraction model that is a trained learning model.

The deformation mask acquisition unit 26 acquires the deformation mask 14 shown in FIG. 3. The deformation mask acquisition unit 26 is the first mask deformation processing step S12 shown in FIG. 1 and executes the deformation mask acquisition step S20 shown in FIG. 2.

The mask deformation processing unit 28 generates the second mask 16 by combining the first mask 12 acquired by the first mask acquisition unit 24 and the deformation mask 14 acquired by the deformation mask acquisition unit 26. The mask deformation processing unit 28 is the first mask deformation processing step S12 shown in FIG. 1 and executes the deformation mask composition step S22 shown in FIG. 2.

In the learning model manufacturing system 20 shown in FIG. 4, a system including the image acquisition unit 22, the first mask acquisition unit 24, the deformation mask acquisition unit 26, and the mask deformation processing unit 28 can be understood as a learning data manufacturing system.

The learning unit 30 performs training using the pair of the first mask 12 acquired by the first mask acquisition unit 24 and the second mask generated by the mask deformation processing unit 28 as the learning data to manufacture the trained learning model 10.

The learning model storage unit 32 stores the learning model 10 manufactured by the learning unit 30. The learning model storage unit 32 may be configured as an external device of the learning model manufacturing system 20 and may be configured to communicate with the learning model manufacturing system 20 via a network.

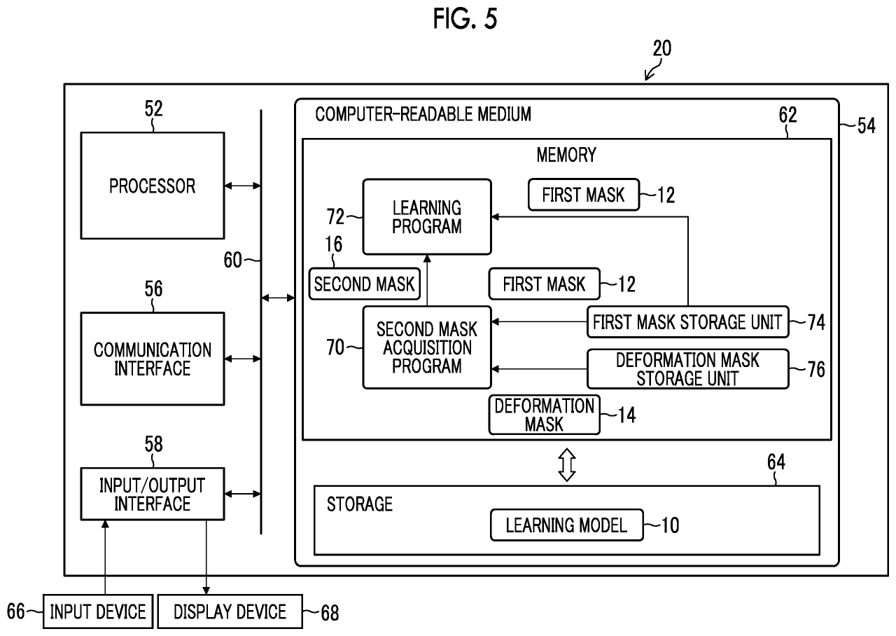

FIG. 5 is a block diagram schematically showing an example of a hardware configuration of the learning model manufacturing system according to the embodiment. The learning model manufacturing system 20 includes a processor 52, a computer-readable medium 54 that is a non-transitory tangible object, a communication interface 56, an input/output interface 58, and a bus 60.

The processor 52 includes a central processing unit (CPU). The processor 52 may include a graphics processing unit (GPU). The processor 52 is connected to the computer-readable medium 54, the communication interface 56, and the input/output interface 58 via the bus 60.

The processor 52 reads out various programs, data, and the like stored in the computer-readable medium 54 and executes various processes. The term program includes the concept of a program module and includes commands conforming to the program.

The computer-readable medium 54 is, for example, a storage device including a memory 62 that is a main memory, and a storage 64 that is an auxiliary storage device. The storage 64 is configured by using, for example, a hard disk device, a solid state drive device, an optical disk, a photomagnetic disk, a semiconductor memory, or the like. The storage 64 may be configured as an appropriate combination of the above-described devices. Various programs, data, and the like are stored in the storage 64.

The hard disk device may be referred to as an HDD by using an abbreviation of Hard Disk Drive in English. The solid state drive device may be referred to as an SSD using the English notation Solid State Drive.

The memory 62 includes an area used as a work area of the processor 52 and an area for temporarily storing a program read from the storage 64 and various types of data. By loading the program that is stored in the storage 64 into the memory 62 and executing commands of the program by the processor 52, the processor 52 functions as a unit for performing various processes defined by the program.

The memory 62 stores various programs such as a second mask acquisition program 70 and a learning program 72 executed by the processor 52, various data, and the like. Each of the second mask acquisition program 70 and the learning program 72 may include a plurality of programs.

The memory 62 includes a first mask storage unit 74 in which the first mask 12 is stored and a deformation mask storage unit 76 in which the deformation mask is stored. The processor 52 executes the second mask acquisition program 70 and generates the second mask 16 by using the first mask 12 and the deformation mask 14. The processor 52 executes the learning program 72 and generates the learning model 10 by using the first mask 12 and the second mask 16. The learning model 10 is stored in the storage 64. The generation referred to here can be included in the concept of acquisition.

The communication interface 56 performs a communication process with an external device by wire or wirelessly and exchanges information with the external device. The learning model manufacturing system 20 is connected to a communication line via the communication interface 56.

The communication line may be a local area network, a wide area network, or a combination thereof. It should be noted that the illustration of the communication line is omitted. The communication interface 56 can play a role of a data acquisition unit that receives input of various data such as the original dataset.

The learning model manufacturing system 20 includes an input device 66 and a display device 68. An input device 66 and a display device 68 are connected to the bus 60 via the input/output interface 58. For example, a keyboard, a mouse, a multi-touch panel, other pointing devices, a voice input device, or the like can be applied to the input device 66. The input device 66 may be an appropriate combination of the keyboard and the like described above.

For example, a liquid crystal display, an organic EL display, a projector, or the like is applied to the display device 68. The display device 68 may be an appropriate combination of the above-described liquid crystal display or the like. The input device 66 and the display device 68 may be integrally configured like a touch panel, and the information processing apparatus, the input device 66, and the display device 68 of the learning model manufacturing system 20 may be integrally configured like a touch panel type tablet terminal. The organic EL display may be referred to as OEL, which is an abbreviation for organic electro-luminescence. Further, EL of an organic EL display is an abbreviation for Electro-Luminescence.

Here, examples of a hardware structure of the processor 52 include a CPU, a GPU, a programmable logic device (PLD), and an application specific integrated circuit (ASIC). The CPU is a general-purpose processor that executes a program and acts as various functional units. The GPU is a processor specialized in image processing.

The PLD is a processor capable of changing a configuration of an electric circuit after manufacturing a device. An example of the PLD is a field programmable gate array (FPGA). The ASIC is a processor comprising a dedicated electric circuit specifically designed to execute a specific process.

One processing unit may be configured by one of the various processors or by a combination of two or more processors of the same type or different types. Examples of a combination of the various processors include a combination of one or more FPGAs and one or more CPUs, and a combination of one or more FPGAs and one or more GPUs. Another example of a combination of various processors includes a combination of one or more CPUs and one or more GPUs.

A plurality of functional units may be configured by using one processor. As an example in which the plurality of functional units are configured by using one processor, there is an aspect in which one processor is configured by applying a combination of one or more CPUs and software, such as system on a chip (SoC) represented by the computer, such as a client or a server, and this processor is made to act as the plurality of functional units.

As another example in which the plurality of functional units are configured by using one processor, there is an aspect in which a processor, which implements the functions of the entire system including a plurality of functional units, is used by using one IC chip.

As described above, various functional units are configured by using one or more of the various processors described above as the hardware structure. Furthermore, the hardware structure of the above described various processors is, more specifically, an electric circuit (circuitry) in which circuit elements such as semiconductor elements are combined.

### Modification Example of Manufacturing Method of Learning Model

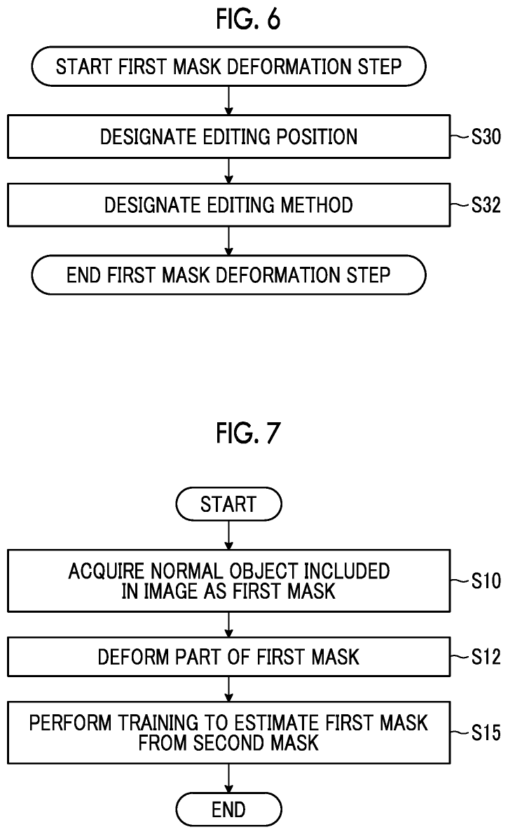

FIG. 6 is a flowchart showing a procedure of another aspect of the mask deformation processing step shown in FIG. 1. In the mask deformation processing step shown in FIG. 6, the deformation process of the first mask, in which the first mask is directly edited, can be performed.

That is, the mask deformation processing step includes an editing position designation step S30 and an editing method designation step S32. In the editing position designation step S30, any point on a closed curve representing an outer periphery of the first mask is designated.

In the editing method designation step S32, an editing method for an editing target point designated in the editing position designation step S30 is designated. For example, there is an example in which the editing target point is moved and a smoothing process is performed on a line segment in the vicinity of the moved editing target point.

In the editing method designation step S32, the first mask editing method of expanding the first mask may be designated to partially expand the first mask, or the first mask editing method of omitting a part of the first mask may be designated to partially contract the first mask.

In the mask deformation processing step shown in FIG. 6, a plurality of second masks different from each other may be generated by applying different editing methods with respect to the same editing target point. Further, in the mask deformation processing step shown in FIG. 6, a plurality of second masks different from each other may be generated by applying the same editing method or different editing methods with respect to a plurality of editing target points.

FIG. 7 is a flowchart showing a flow of a procedure of a manufacturing method of a learning model according to a modification example. The flowchart shown in FIG. 7 includes a learning step S15 instead of the learning step S14 with respect to the flowchart shown in FIG. 1.

In the learning step S15 shown in FIG. 7, training is performed to estimate a normal region, which is a region corresponding to the first mask, from the second mask using the pair of the first mask and the second mask as the learning data. The trained learning model, which is generated by applying the manufacturing method of the learning model shown in FIG. 7, is stored in the learning model storage unit 32 shown in FIG. 4.

### Specific Example of First Mask

As a specific example of the first mask, an example is shown in which a normal anatomical structure is extracted from a medical image and the extracted normal anatomical structure is acquired as the first mask. Here, a kidney is illustrated as the anatomical structure.

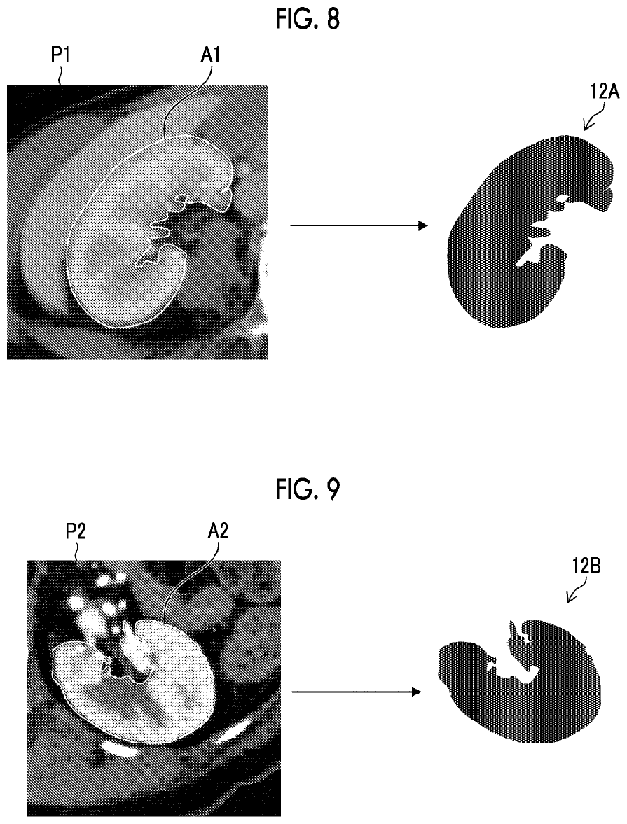

FIG. 8 is a schematic diagram showing a specific example of acquiring a first mask. FIG. 8 shows an example in which a kidney region A1 is extracted from a coronal cross section image P1 of a normal kidney and the kidney region A1 is acquired as a first mask 12A.

FIG. 9 is a schematic diagram showing another specific example of acquiring a first mask. FIG. 9 shows an example in which a kidney region A2 is extracted from an axial cross section image P2 of a normal kidney and the kidney region A2 is acquired as a first mask 12B.

In this way, a large number of medical images including normal organs are prepared, normal organs are extracted from each of a plurality of medical images, and a large number of first masks are acquired. Although FIG. 8 illustrates the coronal cross section image P1, and FIG. 9 illustrates the axial cross section image P2, the medical image including a normal organ may be a sagittal cross section image. Further, the medical image including the normal organ may be a three-dimensional image.

### Specific Example of Deformation Mask

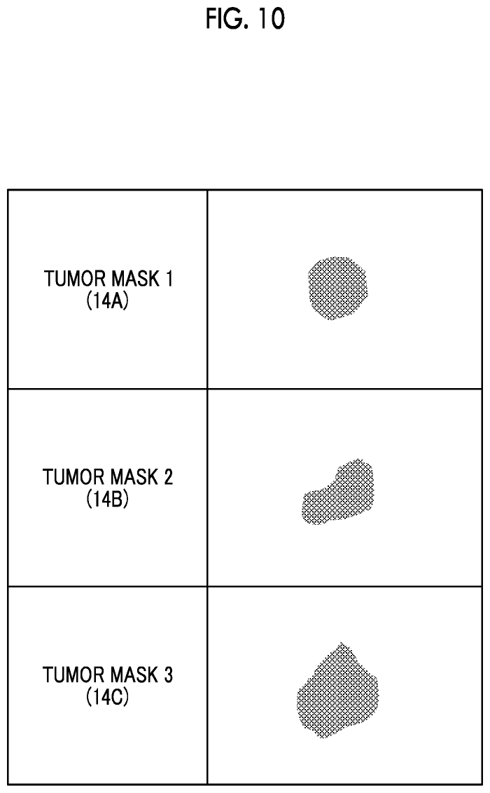

FIG. 10 is a schematic diagram showing a specific example of a deformation mask. FIG. 10 shows an example in which a deformation mask that simulates a lesion such as a tumor is acquired as the deformation mask 14. FIG. 10 illustrates three types of deformation masks 14A, 14B, and 14C that have shapes different from each other.

Instead of the deformation mask that simulates a tumor, an actual tumor extracted from a medical image may be acquired as the deformation mask. Although FIG. 10 illustrates the deformation mask 14A or the like that simulates a tumor, the deformation mask may simulate a shape of a polyp or the like.

### Specific Example of Second Mask

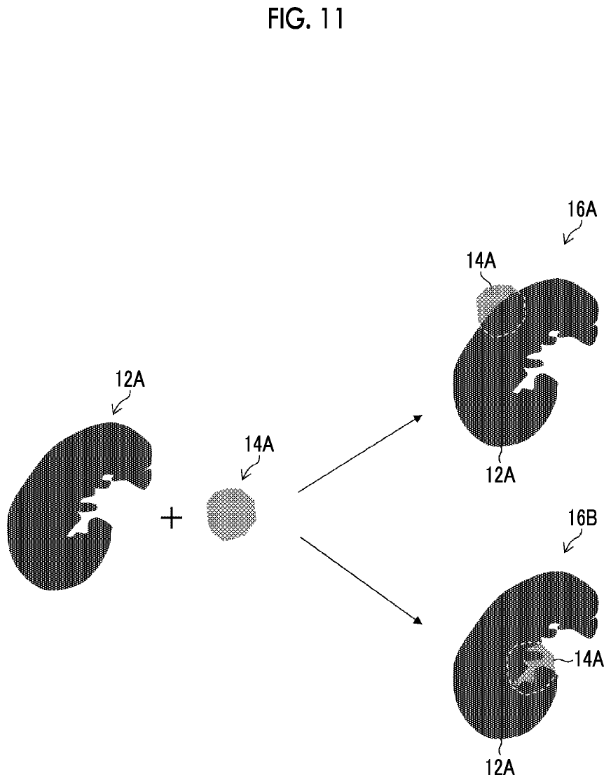

FIG. 11 is a schematic diagram showing a first specific example of acquiring a second mask. FIG. 11 shows an example in which two types of second masks 16A and 16B that are different from each other are acquired by combining the first mask 12A shown in FIG. 8 and the deformation mask 14A shown in FIG. 10. The second mask 16A and the second mask 16B shown in FIG. 11 have the same first mask 12A and the deformation mask 14A, but a position of the first mask 12A on which the deformation mask 14A is superimposed is different.

Although FIG. 11 illustrates the second mask 16A and the second mask 16B in which a part of the deformation mask 14A protrudes from the first mask 12A and the first mask 12A is expanded, a second mask in which a part of the deformation mask 14A is omitted from the first mask 12A may be acquired.

For example, a second mask in which a part of the first mask 12A is omitted may be acquired by eliminating the entire deformation mask 14A from the second mask 16A in which the deformation mask 14A is superimposed on the first mask 12A.

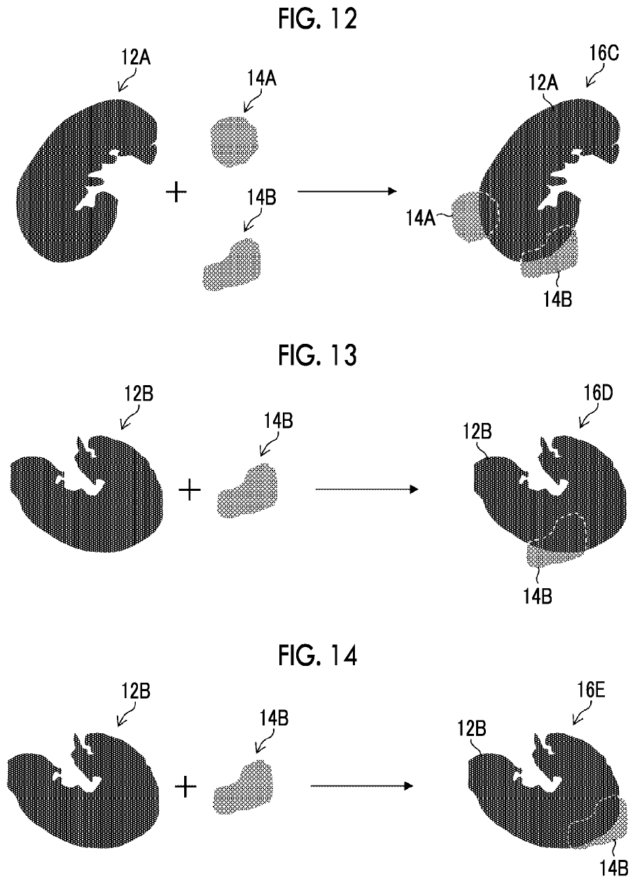

FIG. 12 is a schematic diagram showing a second specific example of acquiring a second mask. As for a second mask 16C shown in FIG. 12, one type of second mask 16C is acquired by combining the first mask 12A shown in FIG. 8 and the deformation masks 14A and 14B shown in FIG. 10.

In the second mask 16C shown in FIG. 12, two types of deformation masks 14A and 14B different from each other are superimposed on the first mask 12A. A position of the first mask 12A on which the deformation mask 14A is superimposed is different from a position of the first mask 12A on which the deformation mask 14B is superimposed.

FIG. 13 is a schematic diagram showing a third specific example of acquiring a second mask. A second mask 16D shown in FIG. 13 is acquired by combining the first mask 12B shown in FIG. 9 and the deformation mask 14B shown in FIG. 10.

FIG. 14 is a schematic diagram showing a fourth specific example of acquiring a second mask. A second mask 16E shown in FIG. 14 is acquired by combining the first mask 12B shown in FIG. 9 and the deformation mask 14B shown in FIG. 10. Regarding the second mask 16E shown in FIG. 14, as compared with the second mask 16D shown in FIG. 13, a position of the first mask 12B on which the second mask 16E is superimposed is different.

That is, the second masks 16A and the like are acquired by randomly combining one or more of a plurality of deformation masks 14A and the like with respect to each of a plurality of first masks 12A and the like. The deformation mask 14A or the like to be superimposed on the first mask 12A or the like may be disposed at a position protruding from the first mask 12A or the like. Since it becomes difficult to detect a difference between the second mask 16A and the like and the first mask 12A and the like when an area of the deformation mask 14A or the like protruding from the first mask 12A or the like is too small, a minimum value of the area of the deformation mask 14A or the like protruding from the first mask 12A or the like may be defined.

Further, a disposition of the deformation mask 14A or the like is applied to the second mask 16A or the like such that the deformation mask 14A or the like does not cover the first mask 12A or the like too much.

### Specific Example of Learning Model

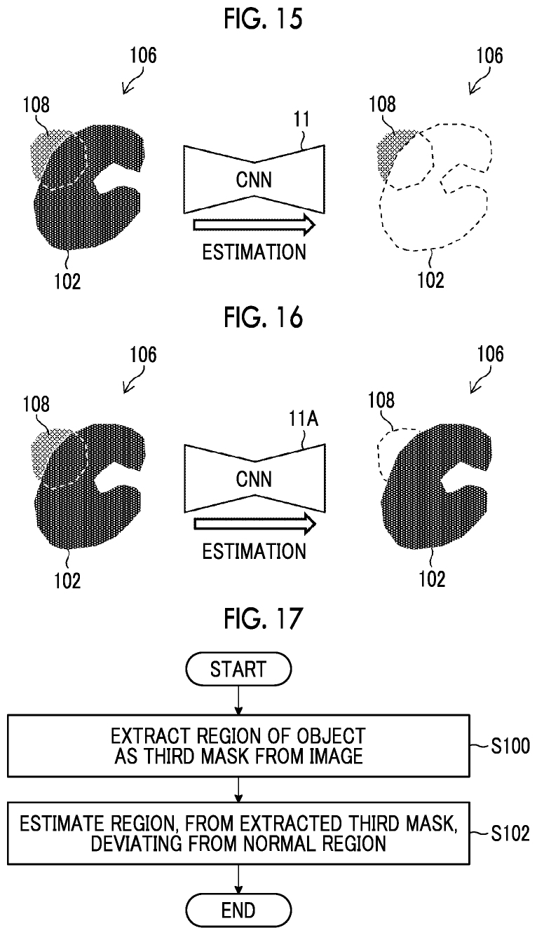

FIG. 15 is a schematic diagram of an estimation model. FIG. 15 shows an estimation model 11 to which the trained learning model 10 shown in FIG. 3 is applied, which is manufactured by using the manufacturing method of the learning model described above. The estimation model 11 is manufactured by performing training to estimate the difference 18 between the first mask 12 and the second mask 16 using the pair of the first mask 12, which is a region in a normal state, and the second mask 16, which includes an abnormal region deviating from the normal state, as the learning data.

The estimation model 11 extracts an object from a processing target image as a third mask 106 and estimates, from the third mask 106, an abnormal region of the third mask 106 recognized as a difference between the normal region 102 and the third mask 106 as a region-of-interest 108.

FIG. 16 is a schematic diagram of another example of an estimation model. An estimation model 11A shown in FIG. 16 is manufactured by performing training to estimate the first mask 12 using the pair of the first mask 12 representing a normal region and the second mask 16 including an abnormal region as the learning data. The estimation model 11A extracts a region of the object from the processing target image as the third mask 106 and estimates the normal region 102, which is a region in a normal state, from the third mask 106.

### Effects of Embodiment

The learning model manufacturing method and the learning model manufacturing system according to the embodiment can obtain the following effects.
1.

One or more first masks 12 representing a normal object are acquired from an image including the normal object. A plurality of second masks 16 are acquired by deforming the first mask. Accordingly, a large amount of learning data is acquired.

A trained learning model is manufactured by performing training to estimate a difference between the first mask 12 and the second mask 16 or to estimate the first mask 12 using the pair of the first mask 12 and the second mask 16 as the learning data. Accordingly, the estimation model of estimating a region deviating from the normal region can be manufactured by using a large amount of learning data. Further, it is possible to reduce the dependence of the texture of an image in the estimation model.
2.

The deformation mask 14 that simulates an abnormal region deviating from the normal region is acquired. The deformation mask 14 is superimposed on the first mask 12, and the first mask 12 is deformed such that a part of the deformation mask 14 protrudes from the first mask 12, and then the second mask 16 is generated. Accordingly, a large number of the second masks 16 having a region similar to the actual abnormal region can be acquired.
3.

A plurality of deformation masks 14 are combined with respect to one first mask 12. Accordingly, a large number of the second masks 16 can be acquired from one first mask 12.
4.

A plurality of deformation masks 14 are acquired by rotating one deformation mask 14. Accordingly, a large number of deformation masks 14 can be acquired from one deformation mask 14.

### Procedure of Estimation Method According to Embodiment

FIG. 17 is a flowchart showing a procedure of the estimation method according to the embodiment. The estimation method shown in FIG. 17 performs estimation of an abnormal region deviating from the normal region in an object from an image including the object. The estimation method shown in FIG. 17 can be performed by using the trained learning model 10 shown in FIG. 4.

That is, in the estimation method shown in FIG. 17, a computer executes a program to execute each step. The number of computers that execute each step included in the estimation method may be one or a plurality of computers. The computer may be a virtual machine.

In a third mask extraction step S100, a region of an object is extracted as the third mask from the processing target image. A known extraction model can be applied to the third mask extraction step S100.

The processing target image may be a two-dimensional image or a three-dimensional image. Examples of an image include a captured image that is obtained by imaging a subject using an imaging device. The captured image may be a medical image in which an anatomical structure of a human body is imaged or may be an inspection image of an industrial product in which the industrial product is imaged. The captured image may be an image in which architecture such as a building, a road, or a bridge is imaged or may be a natural image in which a natural object such as a landscape is imaged.

The object may be an anatomical structure of a human body in a medical image or may be a part of an industrial product to be inspected. The object may be a wall of a building, a pedestal of a bridge, a road, or the like. After the third mask extraction step S100, the process proceeds to the abnormality estimation step S102.

In the abnormality estimation step S102, the abnormality region in the third mask extracted in the third mask extraction step S100 is estimated. The abnormal region is a region deviating from the normal region of the object extracted as the third mask. An abnormal region storing step of storing the extracted abnormal region may be executed after the abnormality estimation step S102. The abnormal region storing step may be included in the abnormality estimation step S102.

The estimation model 11A shown in FIG. 16 can perform an estimation method including a normal estimation step in which a normal region in the third mask is estimated, instead of the abnormality estimation step S102 shown in FIG. 17.

### Outline of Estimation Model

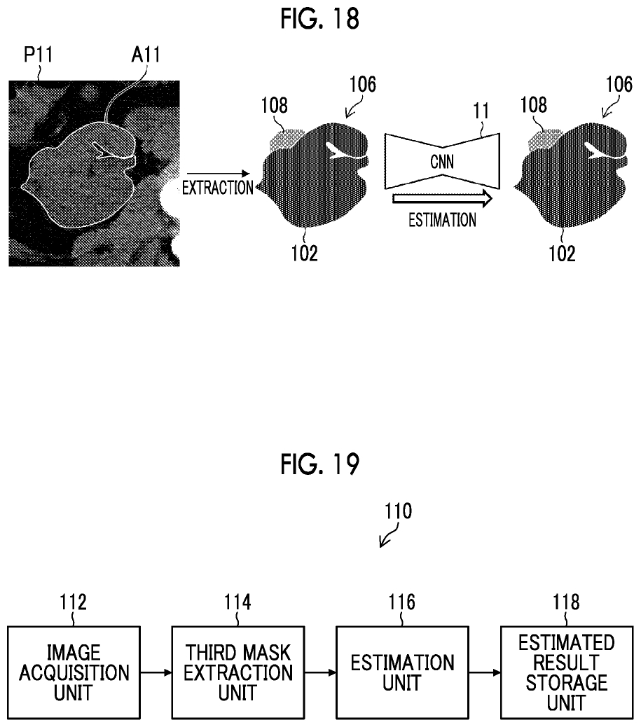

FIG. 18 is a conceptual diagram of the estimation method shown in FIG. 17. In a third mask extraction step S100 shown in FIG. 17, a region A11 of an object is extracted as the third mask 106 from a processing target image P11.

The estimation model 11 is a trained learning model in which training is performed to estimate an abnormal region as the region-of-interest 108 from the third mask 106. In the abnormality estimation step S102 shown in FIG. 17, in a case where the third mask 106 is input to the estimation model 11, the region-of-interest 108 is estimated from the third mask 106. The trained learning model 10 shown in FIG. 4 is applied to the estimation model 11 shown in FIG. 18.

### Configuration Example of Image Processing System

FIG. 19 is a functional block diagram showing an electric configuration of an image processing system according to the embodiment. A computer that executes the estimation method shown in FIG. 17 is applied to an image processing system 110 shown in FIG. 19.

The image processing system 110 includes an image acquisition unit 112, a third mask extraction unit 114, an estimation unit 116, and an estimated result storage unit 118. The image acquisition unit 112 acquires the processing target image that is applied to the third mask extraction step S100 shown in FIG. 17.

The third mask extraction unit 114 executes the third mask extraction step S100 shown in FIG. 17 and extracts the third mask 106 from the processing target image P11 acquired using the image acquisition unit 112.

The estimation unit 116 executes the abnormality estimation step S102 shown in FIG. 17 by using the estimation model 11 shown in FIG. 18 and estimates the region-of-interest 108 from the third mask 106 acquired using the third mask extraction unit 114. The region-of-interest 108, which is estimated using the estimation unit 116, is stored in the estimated result storage unit 118 as an estimated result of the region-of-interest 108 in the processing target image. The estimation unit 116 may function as a processing unit that estimates the normal region from the third mask 106 by using the estimation model 11A shown in FIG. 16.

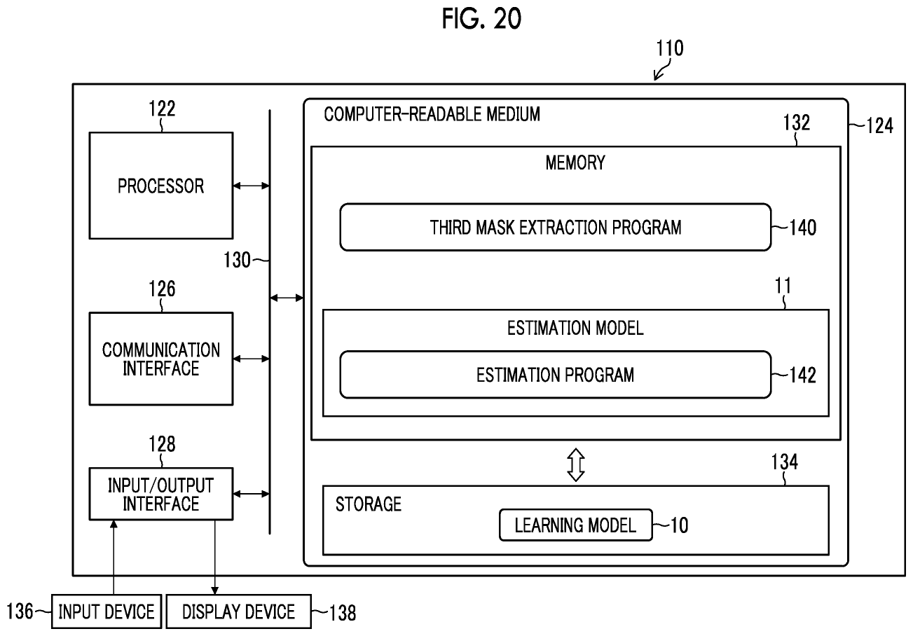

FIG. 20 is a block diagram schematically showing an example of a hardware configuration of the image processing system shown in FIG. 19. A processor 122, a communication interface 126, and an input/output interface 128 shown in FIG. 20 are respectively the same as the processor 52, the communication interface 56, and the input/output interface 58 shown in FIG. 5. Further, an input device 136 and a display device 138 shown in FIG. 20 are respectively the same as the input device 66 and the display device 68 shown in FIG. 5. Here, the description of the processor 122 and the like will be omitted as appropriate.

Further, a computer-readable medium 124 is common to the computer-readable medium 54 shown in FIG. 5 in that it is a storage device including a memory 132 that is a main memory and a storage 134 that is an auxiliary storage device. The memory 132 and the storage 134 may respectively have the same configurations as those of the memory 62 and the storage 64 shown in FIG. 5.

The memory 132 stores a third mask extraction program 140 executed by using the processor 122. The memory 132 stores an estimation program 142 as the estimation model 11.

The third mask extraction program 140 is applied to the third mask extraction unit 114 shown in FIG. 19 and implements a third mask extraction function. The estimation program 142 is applied to the estimation unit 116 and implements an estimation function.

### Application Example to Medical Image

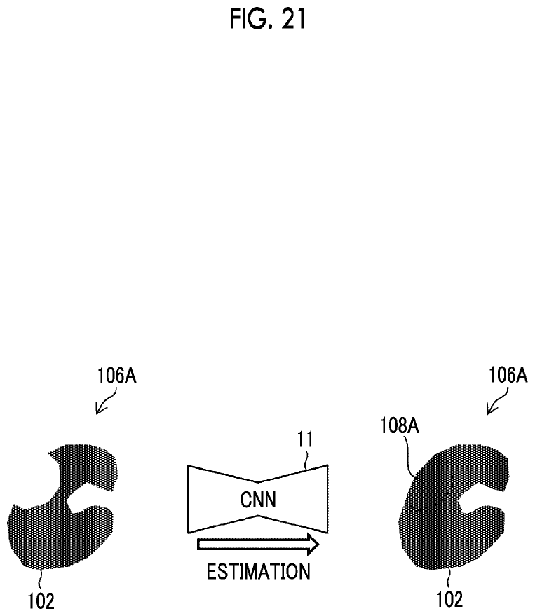

FIG. 21 is a schematic diagram showing an application example to a medical image. Deformation of viscera such as kidney, thyroid, liver, and pancreas may involve partial contraction. FIG. 21 illustrates an estimation model 11 in which a third mask 106A representing an organ as an object is extracted from a medical image, and an abnormal region, which is omitted from a normal region, is estimated as a region-of-interest 108A of the third mask 106A.

Learning data, which is applied to the training of the estimation model 11, may apply the second mask 16 acquired by superimposing the first mask 12 representing a normal organ and the deformation mask 14 representing a partial contraction with respect to the first mask 12 and by eliminating the portion, where the deformation mask 14 is superimposed on the first mask 12, from the first mask 12.

### Effects of Estimation Method and Image Processing System according to Embodiment

The estimation method and the image processing system according to the embodiment can obtain the following effects.
1.

The region-of-interest 108, which is an abnormal region, is estimated from the third mask 106, which is a region of the object extracted from the processing target image P11, by using the estimation model in which training is performed to estimate the difference 18 between the first mask 12 and the second mask 16 using the first mask 12 representing a normal region and the second mask 16, which is obtained by simulating an abnormal region and deforming the normal region, as the learning data. Accordingly, the estimation of the region-of-interest 108 is performed with high accuracy for the processing target image P11.
2.

The normal region is estimated from the third mask 106, which is a region of the object extracted from the processing target image P11, by using the estimation model in which training is performed to estimate the first mask 12 from the second mask 16 using the pair of the first mask 12 and the second mask 16 as the learning data. Accordingly, the estimation of the normal region is performed with high accuracy for the processing target image P11.
3.

Expansion or contraction of the object is estimated as an abnormal region of the object. Accordingly, in a case where the deformation of the object is expansion or contraction of the object, the abnormal region of the object can be estimated.

The technical scope of the present invention is not limited to the scope described in the above-described embodiment. The configurations and the like in each embodiment can be appropriately combined between the respective embodiments without departing from the spirit of the present invention.

### EXPLANATION OF REFERENCES

10: learning model
11: estimation model
11A: estimation model
12: first mask
12A: first mask
12B: first mask
14: second mask
14A: deformation mask
14B: deformation mask
14C: deformation mask
16: second mask
16A: second mask
16B: second mask
16C: second mask
16D: second mask
16E: second mask
18: difference
20: learning model manufacturing system
22: image acquisition unit
24: first mask acquisition unit
26: deformation mask acquisition unit
28: mask deformation processing unit
30: learning unit
32: learning model storage unit
52: processor
54: computer-readable medium
56: communication interface
58: input/output interface
60: bus
62: memory
64: storage
66: input device
68: display device
70: second mask acquisition program
72: learning program
74: first mask storage unit
76: deformation mask storage unit
100: information processing apparatus
102: normal region
106: third mask
106A: third mask
108: region-of-interest
108A: region-of-interest
110: image processing system
112: image acquisition unit
114: third mask extraction unit
116: estimation unit
118: estimated result storage unit
122: processor
124: computer-readable medium
126: communication interface
128: input/output interface
132: memory
134: storage
136: input device
138: display device
140: third mask extraction program
142: estimation program
A1: kidney region
A2: kidney region
A11: region of object
P1: coronal cross section image
P2: axial cross section image
P11: processing target image
S10 to S15: each step of a manufacturing method of a learning model
S20 to S32: each step of a first mask deformation step
S100 to S102: each step of an estimation method

What is claimed is:

1. A manufacturing method of a learning model that estimates a region-of-interest or that estimates a normal region, for an object included in an image, based on a state change with respect to a normal object having a defined state, the manufacturing method of a learning model comprising:
causing a computer to:
acquire a region of the normal object included in a processing target image as a first mask;
generate a second mask by changing a state of the first mask; and
perform training to estimate a difference between the second mask and the first mask as the region-of-interest or perform training to estimate the first mask from the second mask, using the first mask and the second mask as learning data.

2. The manufacturing method of a learning model according to claim 1,
wherein a medical image is applied to the processing target image, and
an anatomical structure is applied as the object.

3. The manufacturing method of a learning model according to claim 2,
wherein in a case where the second mask is generated, a shape simulating a lesion is combined with the first mask to deform a shape of the first mask.

4. The manufacturing method of a learning model according to claim 2,
wherein in a case where the second mask is generated, a shape that is recognized as an omission of the anatomical structure is omitted from the first mask.

5. The manufacturing method of a learning model according to claim 1,
wherein in a case where the second mask is generated, a shape of the first mask is made to expand or the shape of the first mask is made to contract.

6. The manufacturing method of a learning model according to claim 1,
wherein in a case where the second mask is generated, an abnormality simulated shape simulating an abnormality is combined with the first mask to deform a shape of the first mask.

7. The manufacturing method of a learning model according to claim 6,
wherein in a case where the second mask is generated, a plurality of the abnormality simulated shapes are combined with the first mask.

8. The manufacturing method of a learning model according to claim 6,
wherein in a case where the second mask is generated, the abnormality simulated shape, which is rotated, is combined with the first mask.

9. The manufacturing method of a learning model according to claim 1,
wherein in a case where the second mask is generated, an abnormality simulated shape simulating an abnormality is omitted from the first mask to deform a shape of the first mask.

10. A learning model that estimates a region-of-interest or that estimates a normal region, for an object included in an image, based on a state change with respect to a normal object having a defined state, the learning model trained to:
estimate a difference between the second mask and the first mask as the region-of-interest or estimate the first mask from the second mask using a first mask representing a region of the normal object included in a processing target image and a second mask generated by changing a state of the first mask as learning data.

11. A non-transitory, computer-readable tangible recording medium which records thereon a program for estimating a region-of-interest or for estimating a normal region, for an object included in an image, based on a state change with respect to a normal object having a defined state, the program causing, when read by a computer, the computer to realize:
a function of extracting a region of an object included in a processing target image as a third mask; and
a function of estimating, from the third mask, a region deviating from a region of the normal object as the region-of-interest or of estimating the normal region from the third mask.
